(19) United States
(12) Patent Application Publication
(10) Pub. No.: US 2006/0146109 A1
(43) Pub. Date: Jul. 6, 2006

(54) Apparatus including a treatment station for ink on a paper or other substrate

(76) Inventor: Anthony William Goodyer, Durban (ZA)

Correspondence Address: YOUNG & THOMPSON, 745 SOUTH 23RD STREET, 2ND FLOOR, ARLINGTON, VA, 22202, US

(21) Appl. No.: 10/527,407

(22) PCT Filed: Sep. 12, 2003
(86) PCT No.: PCT/ZA03/00133

§ 371 Date: Jan. 18, 2006

(30) Foreign Application Priority Data
Sep. 13, 2002 (ZA) 2002/7353

(51) Int. Cl. B41J 2/01

(52) U.S. Cl. 347/102

(57) ABSTRACT

Apparatus is provided which is associated with a printer of the stencil printing type the apparatus having a conveyor that transports a substrate such as paper from the printer station to a UV light treatment station, the conveyor terminating before the treatment station and including elements for transferring to transfer the paper to the treatment station and elements for removing the paper after treatment.

### TECHNICAL FIELD OF THE INVENTION

This invention relates to a copyprinter of the stencil printing type.

### BACKGROUND ART

One of the disadvantages of the use of so-called grease inks is that the copies tend to smudge due to incomplete flashing of the solvent.

Much attention has been given to the preparation and use of UV-curable inks which avoid this problem but which have to be carefully formulated for success.

Such inks generally comprise a matrix of a monomer which is polymerisable as a result of activation of a photo initiator by a predetermined UV frequency/ies; to which is added pigments, normal additives such as plasticisers, viscosity regulators and the like. The monomer mixture is used as a printing ink which is then transferred to the surface and then irradiated by the UV to provide a rapid curing time, thus preventing offsetting or doubling; and other unacceptable printing characteristics; avoidance of toxic vapours, corrosion, skin irritation and the like; and the choice of theological properties for suitable application.

As examples of these inks may be mentioned those comprising a suitable monomer, or monomers which are polymerisable by chosen photo initiators, the latter being activatable by UV light of a chosen wavelength/s to produce a hard and dry print. Epoxy monomers may be used with the aid of aromatic diazonium salts, the latter decomposing on irradiation by UV to yield a catalyst in the form of a Lewis acid which initiates the polymerisation of the epoxy compound.

The formulation of the ink is one aspect of the printing process. Another is the choice of apparatus so that a successful printing operation is possible, and that the disadvantages outlined above may be avoided or at least greatly reduced.

In RSA Patent 97/11077 a device was described which includes a chamber for directly receiving copies from the output side of a digital duplicator requiring a drying or other treatment process to overcome the problems of ink setoff. The chamber includes UV or other treatment unit/s.

In one form of the invention an endless conveyor is provided through the chamber, the trailing roller of which is hollow and is perforated, and is adapted to receive a vacuum with means under the conveyor to break the vacuum or otherwise release paper after it has been rotated through more than 90 degrees.

Whereas this copyprinter has enjoyed great success there is a risk that should the printer malfunction for any reason, a situation can occur where the belt/s become stationary, the cooling system being switched off and the lamps remain on. The belt/s are exposed to the UV lamps at high temperatures and are subject to severe damage.

Whereas these situations can be monitored by the provision of suitable sensors and safety circuits and the like, this is complicated and expensive. A thermo sensor does nor react quickly enough to prevent overheating of the belt/s and these may catch alight after a short time.

It is an object of the present invention to eliminate or at least greatly reduce the possibility of heat damage to the belt/s of a copyprinter.

A further object of the invention is to provide apparatus which will supplement the advantages of the inks described above

A still further object of the invention is to provide apparatus which avoids or at least greatly reduces the problems of toxic vapours, skin irritation and corrosion and also avoid excess UV radiation from the apparatus.

### DEFINITIONS OF THE INVENTION

According to the invention, apparatus associated with a printer includes a belt/s for transporting paper (or other substrate) from a printing station to treatment station, the conveyor terminating before the treatment station and including means to transfer the paper or substrate to the treatment station, and means to remove the paper or substrate after treatment.

In a preferred form of the invention the treatment station includes a vacuum bed which, when the paper is released from the conveyor, receives the paper into the desired treatment position.

Nip rollers may be positioned at the exit of the treatment station and these serve to release the paper from the conveyor and to draw the paper into position.

The arrangement obviates travel of the belt/s under the treatment lamp and thus reduces or eliminates the chance of fire. In addition a thermo sensor may be located under the lamps to deactivate them when they reach a predetermined elevated temperature.

The nip rollers also serve to prevent any UV light leakage from the exit of the treatment station. This constitutes a further safety factor.

### BRIEF DESCRIPTION OF THE DRAWINGS

An embodiment of the invention is described below with reference to the accompanying drawings, in which:

FIG. 1 is a side view of an arrangement according to the invention,

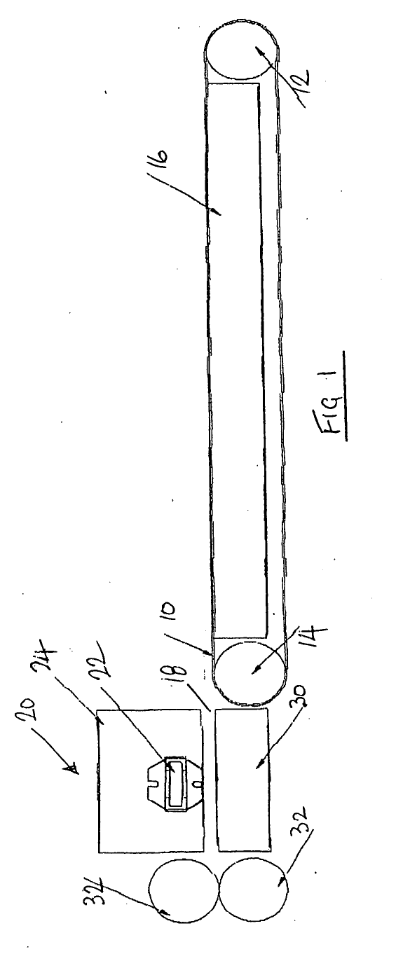

FIG. 2 is a plan view thereof, and

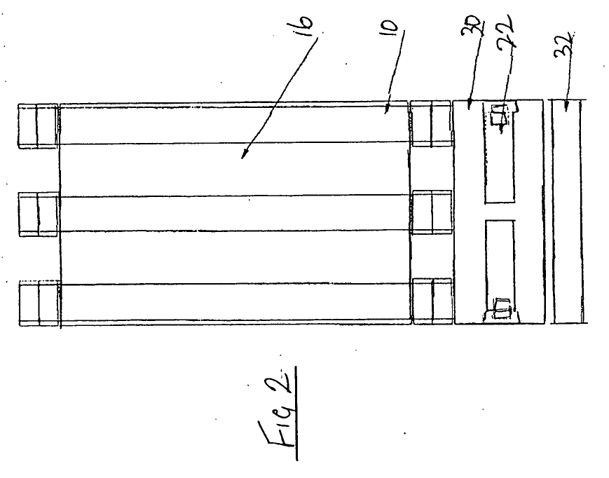

FIG. 3 is an end view.

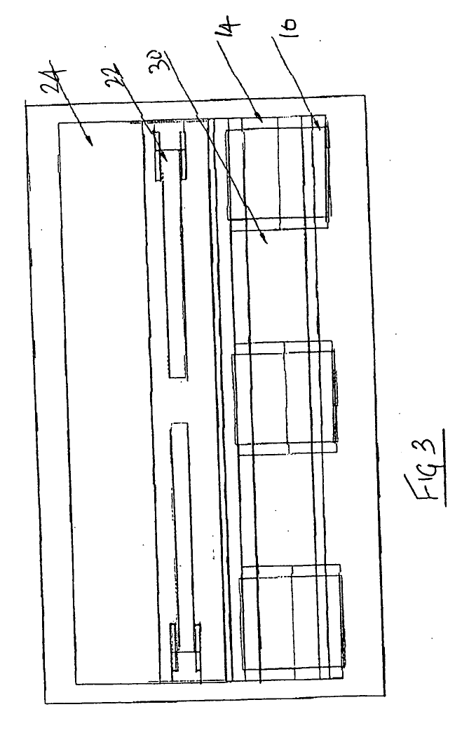

### BEST MODE FOR CARRYING OUT THE INVENTION

In the drawings a conveyor 10 runs on rollers 12, 14 over a vacuum bed 16.

The roller 14 is located at the entrance 18 to the treatment station 20 which comprises a lamp 22 in a box 24.

A vacuum bed 30 is located under the lamp and receives paper from the conveyor by virtue of the nip rollers 32 which draw the paper over the vacuum bed 30—where a vacuum is applied and the paper is firmly located in position for the UV treatment. When this treatment is complete the vacuum is released and the paper removed via the nip rollers.

The ink used with the apparatus may be any of the commercially available inks such as those described, for example in U.S. Pat. Nos. 4,056,453, 5,658,964, 5,749,950 and 5,985,984. Other inks which have proved useful with the apparatus of the invention include those sold under the trade marks SERI INK by the company Sericol Ltd of the United Kingdom.

1. Apparatus adapted to be associated with a printer including a conveyor for transporting paper or other substrate from a printing station to a treatment station characterised in that
the conveyor terminates before the treatment station and including means to transfer the paper or substrate to the treatment station
where it is irradiated with UV light sufficiently for the ink used in the printer to be cured
and means to remove the paper or substrate.

2. The apparatus according to claim 1 characterised in that the treatment station includes a vacuum bed which, when the paper or substrate is released from the conveyor, receives the paper or substrate into the desired UV irradiation position.

3. The apparatus according to claim 1 characterised in that nip rollers are positioned at the exit of the treatment station which serve to release the paper from the conveyor and to draw paper into position.

4. The apparatus according to claim 1 characterised in that one or more thermosensors are located under the UV lamps and are adapted to deactivate the lamps when they reach a predetermined elevated temperature.

5. The apparatus according to claim 2 characterised in that nip rollers are positioned at the exit of the treatment station which serve to release the paper from the conveyor and to draw paper into position.

6. The apparatus according to claim 2 characterised in that one or more thermosensors are located under the UV lamps and are adapted to deactivate the lamps when they reach a predetermined elevated temperature.

7. The apparatus according to claim 3 characterised in that one or more thermosensors are located under the UV lamps and are adapted to deactivate the lamps when they reach a predetermined elevated temperature.

8. The apparatus according to claim 5 characterised in that one or more thermosensors are located under the UV lamps and are adapted to deactivate the lamps when they reach a predetermined elevated temperature.
